(19) United States
(12) Patent Application Publication
(10) Pub. No.: US 2008/0127234 A1
(43) Pub. Date: May 29, 2008

(54) METHODS, SYSTEMS, AND COMPUTER PROGRAM PRODUCTS FOR A REMOTE REQUEST DISPATCHER EXTENSION FRAMEWORK FOR CONTAINER BASED PROGRAMMING MODELS

(75) Inventors: Stephan Hesmer, Gaertringen (DE); Curtiss J. Howard, Raleigh, NC (US); Todd E. Kaplinger, Raleigh, NC (US); Timo Kussmaul, Boeblingen (DE); Maxim A. Moldenhauer, Durham, NC (US)

Correspondence Address: CANTOR COLBURN LLP - IBM RSW, 20 Church Street, 22nd Floor, Hartford, CT, 06103, US

(73) Assignee: International Business Machines Corporation, Armonk, NY (US)

(21) Appl. No.: 11/533,103

(22) Filed: Sep. 19, 2006

(51) Int. Cl. G06F 9/46

(52) U.S. Cl. 719/330

(57) ABSTRACT

A method, system, and computer program product for a remote request dispatcher (RRD) extension framework to transparently invoke container technologies in a multiple application server environment is provided. The method includes executing a local component on a local application server that contains a reference to a remote component on a remote application server. The method also includes receiving a request at the local component for the remote component to perform an action, locating a remote container associated with the referenced remote component, building an RRD request object on the local application server, adding an extension to the RRD request object, and sending the RRD request object with the extension to the remote application server. Furthermore, the method includes receiving the RRD request object with the extension on the remote application server, building an RRD response object, adding an extension handler response extension to the RRD response object, and sending the RRD response object to the local application server.

### CROSS-REFERENCE TO RELATED APPLICATIONS

This application contains subject matter related to the subject matter of the following co-pending application, which is assigned to the same assignee as this application, International Business Machines Corporation of Armonk, N.Y. The below listed application is hereby incorporated herein by reference in its entirety:

U.S. Patent Application Attorney Docket No. RSW920060096US1, entitled METHODS, SYSTEMS, AND COMPUTER PROGRAM PRODUCTS TO TRANSPARENTLY DISPATCH REQUESTS TO REMOTE RESOURCES IN A MULTIPLE APPLICATION SERVER ENVIRONMENT, filed on Sep. 19, 2006.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of The Invention

This invention relates to distributed computing systems, and particularly to methods, systems, and computer program products for a remote request dispatcher extension framework to transparently invoke container technologies in a multiple application server environment.

2. Description of Background

Before our invention, in a managed enterprise environment, seamless integration of remote portlets was not possible. Web Services for Remote Portlets (WSRP) is a standard to include remote portlets, defining a set of operations to access portlets and a complex administration model working within the Internet to allow integration of portlets from different vendors into a portal site. Web services are self-contained, modular applications that can be described, published, located, and invoked over a network. Web services implement a services oriented architecture (SOA), which supports the connecting or sharing of resources and data in a flexible and standardized manner. Universal description, discovery and integration (UDDI) defines a way to publish and discover information about Web services. The UDDI specification defines a standard for the visibility, reusability and manageability for an SOA registry service. With UDDI, a developer can search for a Web service and reuse the Web service in a new application.

A portlet is a kind of application that appears as a defined region on a portal page in a Web browser. A portlet delivers fragment output that is aggregated and displayed by a portal. Portlets provide access to many different applications, services, and Web content.

Although WSRP supports inclusion of remote portlets, it requires manual configuration and administration. WSRP does not support dynamically changing behavior, as portlets must be registered and published by administrators using directory services such as UDDI before portlets can be made available for use by portals. It is desirable to support a dynamically changing environment to allow server traffic to be redistributed during periods of heavy use, or to handle the failure of a server without loss of service. Therefore, what is needed is a method to transparently invoke remote container technologies, such as remote portlets, to allow dynamic changes in container location without manual configuration and administration as required by WSRP.

### SUMMARY OF THE INVENTION

The shortcomings of the prior art are overcome and additional advantages are provided through the provision of methods, systems, and computer program products for a remote request dispatcher (RRD) extension framework to transparently invoke container technologies in a multiple application server environment including a local application server and a remote application server. The method includes executing a local component in a local container on the local application server, where the local component contains a reference to a remote component in a remote container on the remote application server. The method also includes receiving a request at the local component for the remote component to perform an action. The method further includes locating the remote container associated with the referenced remote component, building an RRD request object on the local application server, invoking an extension generator on the local application server, adding an extension to the RRD request object on the local application server, and sending the RRD request object with the extension from the local application server to the remote application server. Furthermore, the method includes receiving the RRD request object with the extension on the remote application server, invoking an extension handler on the remote application server, extracting the extension from the RRD request object extension on the remote application server, invoking the remote container on the remote application server, wrapping the request to the remote component with information received in the RRD request object on the remote application server, building an RRD response object on the remote application server, adding an extension handler response extension to the RRD response object on the remote application server, and sending the RRD response object from the remote application server to the local application server. The method additionally includes receiving the RRD response object on the local application server, extracting the extension from the RRD response object extension on the local application server, and extracting the contents of the RRD response object on the local application server.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

As a result of the summarized invention, technically we have achieved a solution which provides a remote request dispatcher extension framework to transparently invoke container technologies in a multiple application server environment. This invention allows dynamic changes in container location, such as portlet containers, without manual configuration and administration in a multiple application server environment.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a block diagram of a system upon which a remote request dispatcher extension framework may be transparently implemented in exemplary embodiments;

FIG. 2A illustrates one example of a flow diagram describing a process for implementing a remote request dispatcher extension framework in exemplary embodiments;

FIG. 2B illustrates one example of a flow diagram describing a process for implementing a remote request dispatcher extension framework as a continuation of the process illustrated in FIG. 2A in exemplary embodiments.

The detailed description explains the preferred embodiments of the invention, together with advantages and features, by way of example with reference to the drawings.

### DETAILED DESCRIPTION OF THE INVENTION

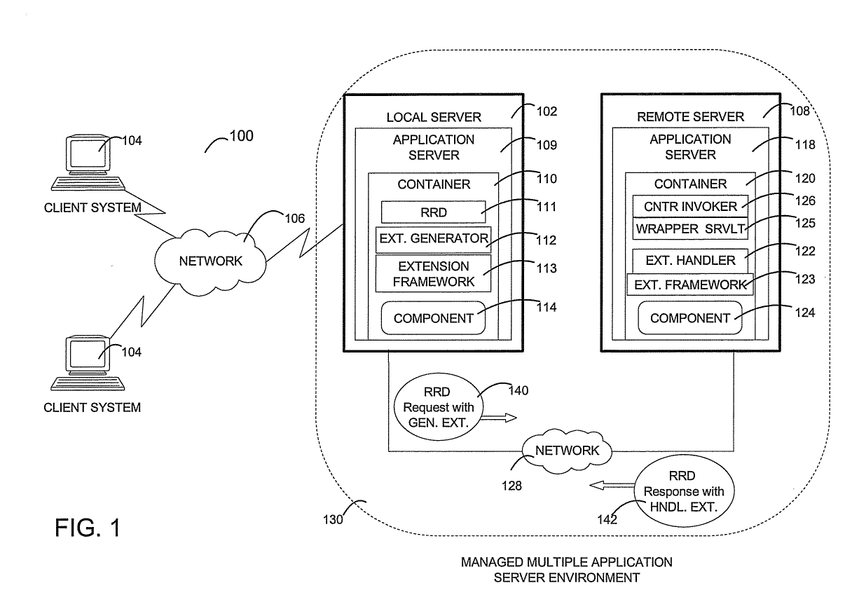

Turning now to the drawings in greater detail, it will be seen that in FIG. 1 there is a block diagram of a system 100 upon which a remote request dispatcher (RRD) extension framework can be implemented in a multiple application server environment. As disclosed in co-pending U.S. Patent Application Attorney docket no. RSW920060096US1, an RRD enables a remote resource to access a requestor's related state information and allows installation of applications on separate application servers without requiring modification of application code. The RRD also enables seamless integration of Web components, such as servlets, across multiple application servers within a managed application server environment. The inventive RRD extension framework disclosed herein allows an RRD to support further programming models and container technologies, such as portlets or Session Initiation Protocol (SIP) components. In exemplary embodiments, an RRD portlet framework leverages the RRD extension framework to enable local and remote transparency for portlets.

The system 100 of FIG. 1 includes a local server 102 in communication with client systems 104 over a network 106. The system 100 of FIG. 1 also depicts a remote server 108 in communication with local server 102 over a network 128. This combination of local server 102, remote server 108, and network 128 is collectively referred to as a managed multiple application server environment 130. Local server 102 may be a high-speed processing device (e.g., a mainframe computer) that handles large volumes of processing requests from client systems 104. In exemplary embodiments, local server 102 functions as an application server, Web server, portal server, and database management server. Client systems 104 may comprise desktop or general-purpose computer devices that generate data and processing requests, such as requests to utilize applications and perform searches. For example, client systems 104 may request Web pages, documents, and files that are stored in various storage systems. In exemplary embodiments, remote server 108, like local server 102, also functions as an application server, Web server, portal server, and database management server. In exemplary embodiments, remote server 108 may not be in communication with client systems 104, while local server 102 may be in communication with client systems 104. Although only two servers 102 and 108 are shown in FIG. 1, it will be understood that multiple servers may be implemented as part of managed multiple application server environment 130, with each server in communication with one another via direct coupling or via one or more networks such as network 128. For example, multiple servers may be interconnected through a distributed network architecture, with each server running zero or more application servers. Furthermore, local server 102 and remote server 108 may be independent software processes both executing on a shared hardware system.

Networks 106 and 128 may be any type of communications network known in the art. For example, networks 106 and 128 may be intranets, extranets, or internetworks, such as the Internet, or a combination thereof. Networks 106 and 128 may be wireless or wireline networks. Networks 106 and 128 may be components of a common network or may be isolated from each other. Network 128 may be a combination of internal hardware and software communication schemes when servers such as local server 102 and remote server 108 embodied in managed multiple application server environment 130 execute on a shared hardware system.

In exemplary embodiments, both local server 102 and remote server 108 run application servers, such as application servers 109 and 118. On local server 102, application server 109 holds container 110, which manages component 114. On remote server 108, application server 118 holds container 120, which manages component 124. A container is part of an application server in which components (e.g., components 114, 124) run. A container may hold one or more components such as servlets, portals, portlets, JavaServer Pages technology (JSP files), and Hypertext Markup Language (HTML) files.

In exemplary embodiments, an application such as a portal running on application server 109 may allow client systems 104 to each receive different personalized content through portlets, which may run as component 114. The users of client systems 104 may each see different customized content, for example personal bank account information or investment portfolios. The information required to construct the customized content for the users of client systems 104 may reside on separate application servers such as application server 109 and application server 118. In exemplary embodiments, component 114 may incorporate the output of the component 124 as part of the response to client systems 104 as described further herein.

Various container based programming models may have different requirements such as access to particular types of data, means for accessing persistent configuration data, methods for generating dynamic content, access to application-wide data, access to private data, and other such variations. Furthermore, container based programming models may be defined to operate in a tiered fashion, such that a higher-level container may rely on a lower-level container for various services and data. To support flexible deployment of containers based on various container based programming models in a managed multiple application server environment, such as managed multiple application server environment 130, the inventive principles of a remote request dispatcher (RRD) extension framework enable the integration of extensions into RRD requests and RRD responses. An extension may be an Extensible Markup Language (XML) fragment that contains a namespace and a Uniform Resource Identifier (URI). In exemplary embodiments, an RRD extension framework is distributed across application servers 109 and 118, and managed though extension framework logic 113 and 123. RRD extension framework logic 113 may invoke an extension generator 112 and RRD extension framework logic 123 may invoke an extension handler 122, both of which support customizable extended information exchange between containers across application server boundaries.

In exemplary embodiments, a remote request dispatcher (RRD) 111 may be employed when a component such as component 114 requests an action from a remote component (e.g., component 124), where component 114 references component 124. The RRD 111 dispatches the request to remote application server 118 as an RRD request object 140. The RRD request object 140 may contain serializable portions of the request context of component 114. The extension framework logic 113 on local application server 109 may invoke extension generator 112 prior to sending the RRD request object 140 to remote application server 118. In exemplary embodiments, extension generator 112 is a Java component that creates an extension of arbitrary data, and then attaches the extension to an RRD request, such as RRD request object 140. The extension to RRD request object 140 may contain additional relevant serializable portions of the request context for container 110. By allowing arbitrary extension data, the RRD extension framework does not impose any limits on the type of containers or programming models.

In exemplary embodiments, extension generator 112 includes an identification attribute, a class attribute that specifies the name of the extension generator implementation class, and an order attribute specifying the extension generator execution order. Additionally, extension generator 112 may include an attribute called “type” that defines a programming model associated with the extension generator to support mapping an RRD request type to an extension generator type. In exemplary embodiments, the type attribute may be “servlet”, “portlet”, or any other supported container type. In exemplary embodiments, an RRD extension framework is extendable through extension generator chains, which may be invoked prior to initiating an RRD request. An extension generator chain is an extension point of an RRD that supports multiple extension generators, such as extension generator 112, to add extensions to an RRD request and process extensions from an RRD response.

In exemplary embodiments, RRD request object with generator extension 140 is transmitted to remote application server 118. The extension framework logic 123 on remote application server 118 may invoke extension handler 122, passing the extension extracted from RRD request object with generator extension 140. In exemplary embodiments, extension handler 122 is a Java component that processes an extension and performs actions based on data contained in the extension. In exemplary embodiments, extension handler 122 includes a namespaceURI and localName attributes, the combination of which defines the qualified name of the extension data that the extension handler 122 can process. The extension handler 122 may additionally include a unique identifier, which may be specified by an identification attribute. A class attribute may be used to specify the class name of the extension handler 122 implementation. In exemplary embodiments, an RRD extension framework is extendable through extension handler chains. In a similar fashion to an extension generator chain, an extension handler chain is a further extension point of an RRD that supports multiple extension handlers, such as extension handler 122. An extension handler chain processes extensions from an RRD request and adds extensions to an RRD response.

Once extension handler 122 has processed an extension, a wrapper servlet 125 is called, which further invokes remote container 120 via a container invoker 126. The remote container 120 performs the requested action on remote component 124. Once the RRD request is processed on remote application server 118, an RRD response object 142 is created, and the extension handler 122 attaches a response extension to the RRD response object 142. The extension generator 112 then extracts the response extension and performs actions based on data contained in the extension attached to RRD response object 142. The RRD response object 142 is further processed to extract the response from remote component 124.

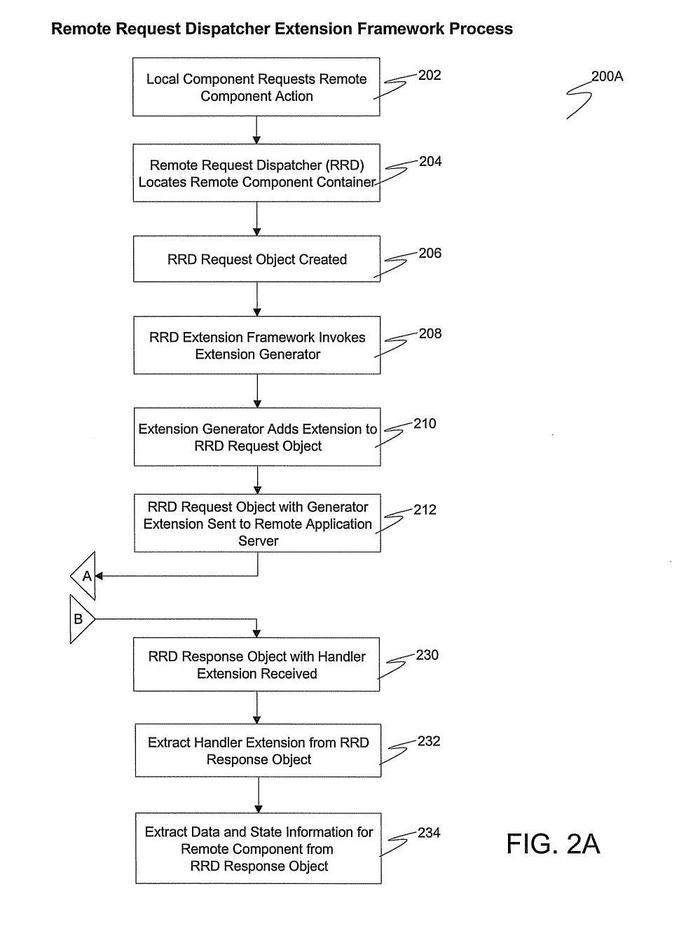

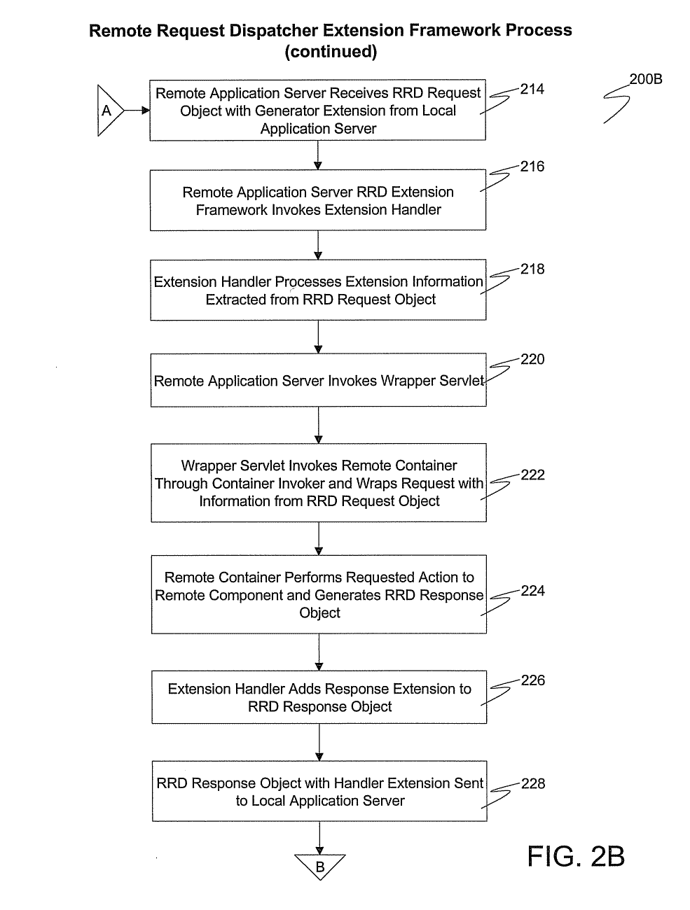

Turning now to FIG. 2A and FIG. 2B, a process to implement an RRD extension framework in accordance with exemplary embodiments is provided in process flows 200a and 200b. Process flow 200A depicts a request to a remote component using an RRD extension framework that continues into process flow 200b , which depicts a response through an RRD extension framework, and the process flow then returns to 200a where the contents of the RRD response output is parsed to extract any extensions and other information. At process step 202, a local component 114 in container 110 receives a request from client system 104, which requires remote component 124 in remote container 120 to perform an action. At process step 204, RRD 111 locates remote container 120 that holds remote component 124 to enable dispatching the request. RRD 111 may incorporate a web services dynamic workload management client that is able to locate the remote component 124 using technologies known in the art, such as a combination of On Demand Config and Unified Cluster Framework technology. At process step 206, an RRD request object 140 is created to send the request and associated information to remote container 120 for remote component 124. At process step 208, extension framework logic 113 invokes extension generator 112 according to the request type. In exemplary embodiments, extension generator 112 may be part of an extension generator chain. At process step 210, extension generator 112 adds an extension to the outbound RRD request object 140. In exemplary embodiments, each generator contained in an extension generator chain may add extensions to the outbound RRD request object 140. At process step 212, the RRD request object with the generator extension 140 is sent through network 128 to remote application server 118.

Continuing to process flow 200B, at process step 214, remote application server 118 receives the RRD request object with the generator extension 140 from local application sever 109. At process step 216, remote application server 118 invokes extension handler 122 through extension framework logic 123. In exemplary embodiments, extension framework logic 123 correlates extensions and extension elements by use of an extension qualified name and id, invoking an extension handler 122, and passing an associated extension extracted from the RRD request object 140. When multiple extension handlers are part of a chain, each extension handler may be called in sequence. At process step 218, extension handler 122 processes extension information extracted from RRD request object 140. In exemplary embodiments, once an extension handler chain has processed every extension, the RRD request is processed. At process step 220, a wrapper servlet 125 is invoked on remote application server 118. At process step 222, wrapper servlet 125 invokes remote container 120 and wraps the request for remote component 124 with information from RRD request object 140. At process step 224, remote container 120 performs the requested action to remote component 124 and generates a resulting RRD response object 142. At process step 226, extension handler 122 adds a response extension to RRD response object 142. In exemplary embodiments, when multiple extension handlers are part of a chain, upon generation of an RRD response object 142, extension framework logic 123 traverses the extension handler chain, thus enabling each extension handler, such as extension handler 122, to add extensions to the RRD response object 142. At process step 228, RRD response object with handler extension 142 is sent to local application server 109 through network 128.

Returning to process flow 200A, at process step 230, local application server 109 receives RRD response object with handler extension 142. At process step 232, extension framework logic 113 invokes extension generator 112 to process an extracted handler extension from RRD response object 142. In exemplary embodiments, extension framework logic 113 may traverse a generator chain, thus enabling each extension generator, such as extension generator 112, to process extensions from RRD response object 142. At process step 234, data and state information for remote component 124 are extracted from RRD response object 142, allowing local component 114 to complete a response to client system 104.

In exemplary embodiments, an RRD portlet framework uses the RRD extension framework to allow dispatching requests to portlets, in addition to servlets, that run in a remote Java Virtual Machine (JVM). The RRD extension framework may provide specific extension generators and extension handlers that marshal portlet-specific information along with the RRD request, such as information that is required by a portlet container. Portals that use customized containers and provide extended functionality, such as specialized implementations of container services, can add their own extensions to marshal extended information that may be needed for their service implementations.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for implementing a remote request dispatcher (RRD) extension framework in a managed multiple application server environment comprised of a local application server and a remote application server, said method comprising:
executing a local component in a local container on the local application server, said local component containing a reference to a remote component in a remote container on the remote application server;
receiving a request at the local component for the remote component to perform an action;
locating the remote container associated with the referenced remote component;
building an RRD request object on the local application server;
invoking an extension generator on the local application server;
adding an extension to the RRD request object on the local application server;
sending the RRD request object with the extension from the local application server to the remote application server;
receiving the RRD request object with the extension on the remote application server;
invoking an extension handler on the remote application server;
extracting the extension from the RRD request object extension on the remote application server;
invoking the remote container on the remote application server;
wrapping the request to the remote component with information received in the RRD request object on the remote application server;
building an RRD response object on the remote application server;
adding an extension handler response extension to the RRD response object on the remote application server;
sending the RRD response object from the remote application server to the local application server;
receiving the RRD response object on the local application server;
extracting the extension from the RRD response object extension on the local application server; and
extracting the contents of the RRD response object on the local application server.

2. The method of claim 1 further comprising:
chaining extension generators on the local application server, wherein multiple extension generators add extensions to the RRD request object and extract extensions from the RRD response object on the local application server.

3. The method of claim 1 further comprising:
chaining extension handlers on the remote application server, wherein multiple extension handlers extract extensions from the RRD request object and add extensions to the RRD response object on the remote application server.

4. The method of claim 1, wherein the local container on the local application server is a portlet container.

5. The method of claim 1, wherein the remote container on the remote application server is a portlet container.

6. The method of claim 1, wherein the local container on the local application server is a servlet container.

7. The method of claim 1, wherein the remote container on the remote application server is a servlet container.

8. A system for providing a remote request dispatcher (RRD) extension framework in a managed multiple application server environment, comprising:
a local application server, the local application server performing:
executing a local component in a local container on the local application server, said local component containing a reference to a remote component in a remote container on the remote application server;
receiving a request at the local component for the remote component to perform an action;
locating the remote container associated with the referenced remote component;
building an RRD request object;
invoking an extension generator;
adding an extension to the RRD request object;
sending the RRD request object with the extension to the remote application server;
receiving an RRD response object;
extracting an extension from the RRD response object extension; and
extracting the contents of the RRD response object; and
a remote application server, said the remote application server performing:
receiving the RRD request object with the extension;
invoking an extension handler;
extracting the extension from the RRD request object extension;
invoking the remote container;
wrapping the request to the remote component with information received in the RRD request object;
building an RRD response object;
adding an extension handler response extension to the RRD response object; and
sending the RRD response object to the local application server.

9. The system of claim 8, wherein the local application server further performs:
chaining extension generators, wherein multiple extension generators add extensions to the RRD request object and extract extensions from the RRD response object.

10. The system of claim 8, wherein the remote application server further performs:
chaining extension handlers, wherein multiple extension handlers extract extensions from the RRD request object and add extensions to the RRD response object.

11. The system of claim 8, wherein the local container on the local application server is a portlet container.

12. The system of claim 8, wherein the remote container on the remote application server is a portlet container.

13. The system of claim 8, wherein the local container on the local application server is a servlet container.

14. The system of claim 8, wherein the remote container on the remote application server is a servlet container.

15. A computer program product for providing a remote request dispatcher (RRD) extension framework in a managed multiple application server environment comprised of a local application server and a remote application server, said computer program product including instructions for implementing a method, comprising:
executing a local component in a local container on the local application server, said local component containing a reference to a remote component in a remote container on the remote application server;
receiving a request at the local component for the remote component to perform an action;
locating the remote container associated with the referenced remote component;
building an RRD request object on the local application server;
invoking an extension generator on the local application server;
adding an extension to the RRD request object on the local application server;
sending the RRD request object with the extension from the local application server to the remote application server;
receiving the RRD request object with the extension on the remote application server;
invoking an extension handler on the remote application server;
extracting the extension from the RRD request object extension on the remote application server;
invoking the remote container on the remote application server;
wrapping the request to the remote component with information received in the RRD request object on the remote application server;
building an RRD response object on the remote application server;
adding an extension handler response extension to the RRD response object on the remote application server;
sending the RRD response object from the remote application server to the local application server;
receiving the RRD response object on the local application server;
extracting the extension from the RRD response object extension on the local application server; and
extracting the contents of the RRD response object on the local application server.

16. The computer program product of claim 15, further comprising instructions for implementing:
chaining extension generators on the local application server, wherein multiple extension generators add extensions to the RRD request object and extract extensions from the RRD response object on the local application server.

17. The computer program product of claim 15, further comprising instructions for implementing:
chaining extension handlers on the remote application server, wherein multiple extension handlers extract extensions from the RRD request object and add extensions to the RRD response object on the remote application server.

18. The computer program product of claim 15, wherein the local container on the local application server is a portlet container or a servlet container.

19. The computer program product of claim 15, wherein the remote container on the remote application server is a portlet container or a servlet container.
